(19) United States
(12) Patent Application Publication
(10) Pub. No.: US 2008/0174931 A1
(43) Pub. Date: Jul. 24, 2008

(54) Vertical electrode layer design to minimize flex cracks in capacitors

(76) Inventors: Daniel J. Skamser, Simpsonville, SC (US); Lonnie G. Jones, Greenville, SC (US)

Correspondence Address: NEXSEN PRUET, LLC, P.O. BOX 10648, GREENVILLE, SC, 29603, US

(21) Appl. No.: 11/654,787

(22) Filed: Jan. 18, 2007

(51) Int. Cl. H01G 4/002; H01G 4/228

(52) U.S. Cl. 361/272; 361/306.1

(57) ABSTRACT

An electrical component with a substrate having a planar surface. A capacitor is provided having a plurality of first plates and second plates wherein the first plates and second plates are non-contacting and in common planes. A plurality of third plates are parallel to the first plates and the second plates and interleaved between the planes. A first external termination is in electrical contact with the plurality of first plates and a second external termination is in electrical contact with the plurality of second plates. The capacitor is mounted on the substrate with the first plates, the second plates and the third plates perpendicular to the planar surface.

### FIELD OF THE INVENTION

The present invention is related to a capacitor and specific orientation of the capacitor on a substrate to decrease stress crack propagation. More specifically, the present invention is related to vertical mounted capacitors for decreased stress crack propagation.

### BACKGROUND OF THE INVENTION

Capacitors are well known in the art of electrical components. Capacitors typically comprise parallel plates, which act as charge collectors and sources, with a dielectric there between. The function of capacitors is well known and further discussion is not warranted herein.

The capacitors are elements that are added to circuitry with primarily the singular function of being a source of energy for the circuit to function. In this application, it is counted on only as a reserve of energy mounted onto circuit traces, and in itself does not contribute to the circuit charge or discharge path.

Multilayer ceramic capacitors (MLCC) are used in a variety of electrical applications including automotive products, aerospace products, heavy equipment and military applications, for example. Typical applications include telematics, entertainment systems, drive control systems, environmental control systems, console instrumentation, communication systems, weapons fire control systems, detection systems and the like. Many applications involve particularly harsh environments including extreme temperature and humidity excursions, vibrations, jolting, and other activities harmful to the electronics. All of these conditions can lead to substrate flexing which places stresses on the capacitor. The stresses due to flexing typically lead to failures in the insulation and are referred to as insulation failure (IR) losses.

Flex cracks are a common problem in MLCC's often leading to loss of capacitance and IR loss. Loss in capacitance is considered to be the most severe issue with regards to the percentage of diagnosed capacitor failures. They can occur in many areas of the lifecycle including manufacturing, device assembly, module assembly and finally during the ultimate application or use. Among the problems that can occur as a result of flex cracks are the previously mentioned insulation failure losses and loss of capacitance. The more critical problem is IR loss since it typically causes malfunction of the device and possibly the entire module. It is a well known phenomenon that when failed devices are analyzed low insulation resistance is a common root cause of failure in MLCC containing devices.

Various designs have been described to avoid low IR caused by flex cracks. These include open-mode, floating electrode and flexible termination capacitors. The open-mode design use wide end margins to prevent the crack from propagating into the active area. Floating electrode capacitors use coplanar non-contacting electrode plates with non-terminated plates interleaved between the planes. Flexible terminations create an elastic connection to the substrate, or printed circuit board, so that small displacements at the termination joint on the substrate can be withstood without cracks occurring in the capacitor. In addition, with the occurrence of large displacements the strength of the flexible termination is low enough to allow a preferential pathway for flex cracks to travel.

Eliminating flex cracks has proven to be a very difficult task using the techniques currently employed in the art. The present invention provides a unique approach which mitigates the losses in capacitance and IR losses due to stress cracks. The invention is synergistic with other methods directed at mitigating stress damage.

### SUMMARY OF THE INVENTION

It is an object of the invention to provide an electrical component with improved resistance to stress crack failure.

It is another object of the present invention to provide a printed circuit comprising an electrical component wherein conventional manufacturing equipment can be used and wherein the capacitors have improved resistance to stress crack failure.

It is another object of the present invention to provide a capacitor which is insensitive to stress cracks and which can withstand stresses with minimal loss of capacitance.

These and other advantages, as will be realized, are provided in an electrical component with a substrate having a planar surface. A capacitor is provided having a plurality of first plates and second plates wherein the first plates and second plates are non-contacting and in common planes. A plurality of third plates are parallel to the first plates and the second plates and interleaved between the planes. A first external termination is in electrical contact with the plurality of first plates and a second external termination is in electrical contact with the plurality of second plates. The capacitor is mounted on the substrate with the first plates, the second plates and the third plates perpendicular to the planar surface.

Yet another embodiment is provided in a printed circuit board. The printed circuit board has a substrate with a planar surface and circuit traces on the planar surface. A capacitor is in electrical contact with the circuit traces wherein the capacitor has a plurality of first plates and second plates wherein the first plates and second plates are non-contacting and in common planes. A plurality of third plates are parallel to the first plates and the second plates and interleaved between the planes. A first external termination is in electrical contact with the plurality of first plates. A second external termination is in electrical contact with the plurality of second plates. The capacitor is mounted on the substrate with the first plates, second plates and third plates perpendicular to the planar surface.

A further embodiment is provided in an electrical component with a substrate having a planar surface. The capacitor is provided with a plurality of first plates and second plates wherein the first plates and second plates are parallel and alternating with dielectric there between. A first external termination is in electrical contact with the plurality of first plates. A second external termination is in electrical contact with the plurality of second plates. The first plates are separated a distance from the furthest extent of the second external termination. The second plates are separated a distance from the furthest extent of the first external termination. The capacitor is mounted on the substrate and the first plates and second plates are perpendicular to the planar surface.

Another embodiment is provided in an electrical component having a substrate with a planar surface. A capacitor is provided with a plurality of first plates and second plates wherein the first plates and second plates are parallel and alternating. A first external termination is in electrical contact with the plurality of first plates. A second external termination is in electrical contact with the plurality of second plates. A first lead frame is attached to the first external termination and a second lead frame is attached to the second external termination. The first lead frame and said second lead frame are mounted on the substrate with the first plates and second plates perpendicular to the planar surface.

### BRIEF DESCRIPTION OF THE DRAWINGS

FIG. 1 is a cross-sectional schematic view of a capacitor.

FIG. 2 is a cross-sectional schematic view of a floating electrode capacitor.

FIG. 3 is a cross-sectional schematic view of a floating electrode capacitor mounted in a vertical orientation.

FIG. 4 is a cross-sectional schematic view of an open-mode capacitor.

FIG. 5 is a cross-sectional schematic view of a floating electrode capacitor mounted in a vertical orientation.

FIG. 6 is a cross-sectional view of a capacitor mounted in vertical orientation with a flexible termination.

FIG. 7 is a schematic view of a flex test device.

### DETAILED DESCRIPTION OF THE DRAWINGS AND INVENTION

The invention will be described with reference to the drawings forming an integral part of the disclosure. In the various figures similar elements will be numbered accordingly.

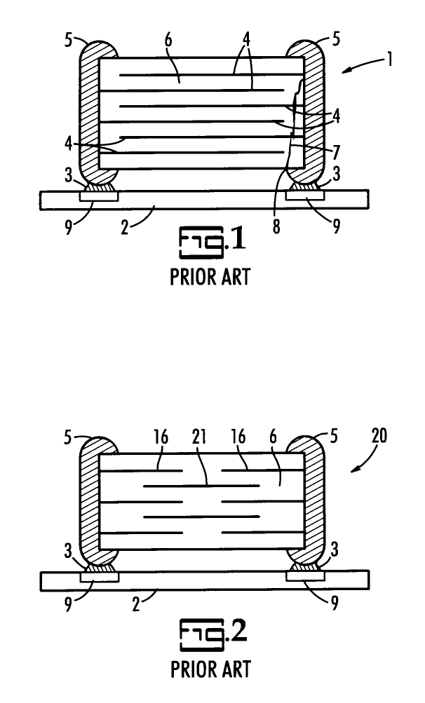

A capacitor is illustrated in schematic cross-sectional view in FIG. 1. The capacitor, generally represented at 1, is attached to a substrate, 2, by solder, 3, at a circuit trace, 9. The capacitor comprises alternating plates, 4, alternately in contact with the external terminations, 5. A dielectric, 6, is between the plates. Flexing of the substrate places a torque on the capacitor. Once the torque reaches a critical level a stress crack, 7, is created. As illustrated in FIG. 1 the stress crack is generally directed away from the substrate and often initiates at the terminal edge, 8, of the external termination. While not readily visible from this view the stress crack is typically completely through the capacitor and causes a fracture of at least some of the plates thereby at least decreasing, and often eliminating, the capacitance. As would be readily realized a typical capacitor may have hundreds of plates and the number of plates subject to shearing is very large relative to the schematic view illustrated herein.

FIG. 2 illustrates in cross-sectional schematic view a floating electrode design. The floating electrode capacitor, 20, has adjacent non-connecting conductive plates, 16, and floating plates, 21. The non-connecting conductive plates are preferably in a common plane. The current path is from non-connecting terminating plates on one side to the floating plates then to the non-connecting terminating plates on the opposing side.

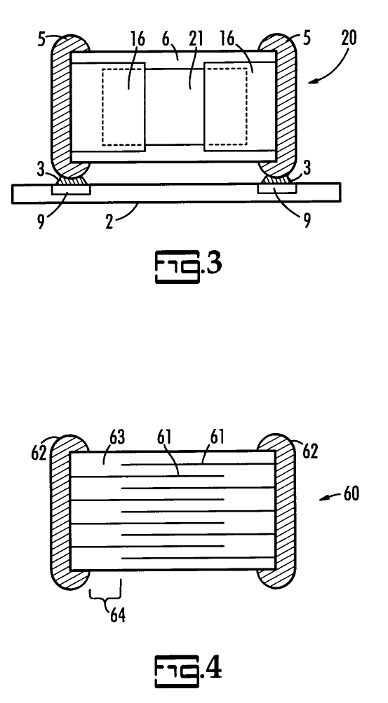

FIG. 3 illustrates a floating electrode capacitor, 20, mounted in vertical position with the plates perpendicular to the substrate, 2. As further described infra a floating electrode capacitor mounted in a vertical orientation performs significantly better in resisting damage due to stress crack propagation than conventional capacitors.

FIG. 4 illustrates an open mode capacitor in cross-sectional view. In FIG. 4, the open-mode capacitor, 60, comprises alternating plates, 61, of opposing polarity. Each plate is in electrical contact with only one external termination, 62, with alternating plates terminating at opposing external terminations. The non-terminated end of each plate is separated by a distance, 64, from the furthest inward extent of the external termination.

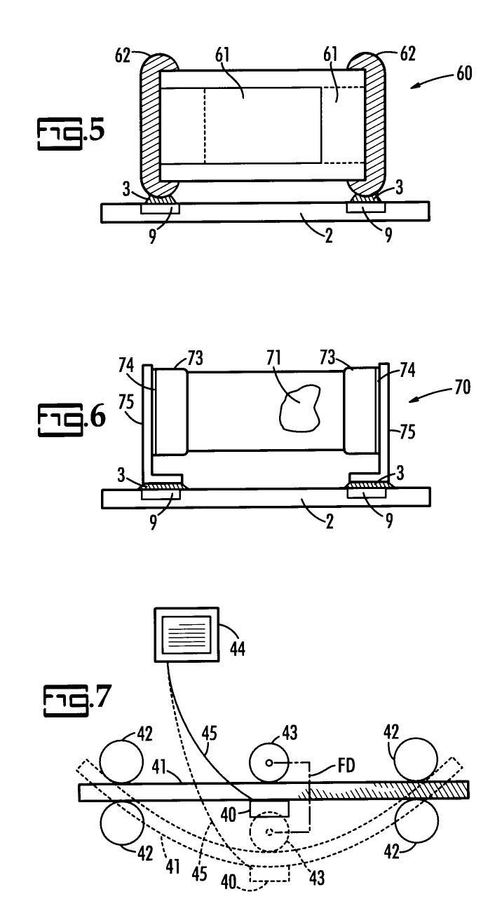

FIG. 5 illustrates a cross-sectional view of an open mode capacitor, 60, mounted in vertical position with the plates perpendicular to a substrate, 2. As further described infra an open-mode electrode capacitor mounted in a vertical orientation performs significantly better in resisting damage due to stress crack propagation than conventional capacitors.

FIG. 6 schematically illustrates a capacitor in partial cutaway with a flexible termination mounted in a vertical orientation. The capacitor, 70, comprises plates, 71, which are perpendicular to the substrate, 2. Lead frames, 74, secured to the external termination by a conductive connector, 74, such as solder provide electrical contact between the external terminations and circuit traces, 9, on the substrate, 2, by solder, 3.

It is most preferable that the capacitor have a rectangular configuration most preferably with the thickness being less than the width. The width is determined parallel to the plates and the thickness is determined perpendicular to the plates. If a square configuration is used it is difficult to insure that the plates are perpendicular to the substrate unless a physical element is included in the shape to indicate orientation. Pick and place devices can not easily distinguish orientation for a square, or symmetrical, part easily and elements to indicate orientation are cost prohibitive. Therefore, it is most preferable to avoid square capacitors due to the inability to easily predict the orientation of the plates in a manufacturing environment. In a particularly preferred embodiment the width is at least about 10% greater than the thickness. This allows for the correct orientation of capacitors with the electrode plates in a vertical orientation.

The capacitor must be designed to accommodate pick and place equipment and insure that the plates will be mounted in a vertical orientation. Typically, parts are placed on a printed circuit board using automated pick and place equipment that removes parts from a tape. The tape has slots in which the capacitors reside and the tape is typically on a reel. The parts must be properly oriented within the slots of the tape to insure vertical orientation. Most reelers utilize precision slots and vibration to align and load parts into the pockets of the tape packaging. To insure adequate placement within the indention it is preferable for the parts to have a width to thickness ratio greater than 1.1 to 1.0 for the parts to always fall properly into the slots. Decreasing the center of gravity of the parts drives them to orient with the wide side down.

The flex test is accomplished by mounting a capacitor to a test board. The test board is then inserted into a flex test device as illustrated schematically in FIG. 7. In FIG. 7 the capacitor, 40, is mounted on a substrate, 41, in a conventional manner. The substrate is then inserted into a flex test device. The flex test device comprises idler rollers, 42, preferably separated by about 90 mm which secure the edges of the board yet allow the board to flex freely. A flex roller, 43, preferably on the side of the substrate opposite to the capacitor pushes against the substrate causing the substrate to flex to a desired amount as indicated by the dotted-line representation. The flex roller, and capacitor, are preferably equidistant between the idler rollers. The flex distance (FD) is determined as the distance traveled by the axle of the flex roller. The flex distance may be determined by another point, such as the distance traveled by a face of the capacitor, provides equivalent results. A monitor, 44, preferably connected to the capacitor by a communication link, 45, allows the electrical properties of the capacitor to be monitored before, during or after flex.

The flex distance can be converted to strain according to the following equations:

The radius (R) is calculated as:

R=[H²+(0.25L²)]/2H

wherein:
H=displacement in mm; and
L=the span between idler rollers in mm.
   The strain, S, is then calculated as:

S=T/2R;

wherein
T=thickness of substrate in mm.

It is preferable to test one capacitor per board though similar test could be developed testing multiple capacitors on one or more boards. It is particularly preferred to measure capacitance as the part is flexed and, in some test, a change in capacitance of 0.2% within 50 msec. is considered to be a failure. Approximately 20 capacitance readings during the flex test is considered optimal.

The dielectric layers have an appropriate Curie temperature which is determined in accordance with the applicable standards by suitably selecting a particular composition of dielectric material. Typically the Curie temperature is higher than 45° C., especially about 65° C. to 125° C.

Each dielectric layer preferably has a thickness of up to about 50 μm, more preferably up to about 20 μm. The lower limit of thickness is about 0.5 μm, preferably about 2 μm. The present invention is effectively applicable to multilayer ceramic chip capacitors having such thin dielectric layers for minimizing a change of their capacitance with time. The number of dielectric layers stacked is generally from 2 to about 300, preferably from 2 to about 200.

The conductor which forms the internal electrode layers is not critical, although a base metal preferably is used since the dielectric material of the dielectric layers has anti-reducing properties. Typical base metals are nickel and nickel alloys. Preferred nickel alloys are alloys of nickel with at least one member selected from Mn, Cr, Co, and Al, with such nickel alloys containing at least 95 wt % of nickel being more preferred. It is to be noted that nickel and nickel alloys may contain up to about 0.1 wt % of phosphorous and other trace components.

The thickness of the internal electrode layers may be suitably determined in accordance with a particular purpose and application although its upper limit is typically about 5 μm, preferably about 2.5 μm, and its lower limit is typically about 0.5 μm, preferably about 1 μm.

The conductor which forms the external electrodes is not critical, although inexpensive metals such as nickel, copper, and alloys thereof are preferred. The thickness of the external electrodes may be suitably determined in accordance with a particular purpose and application although it generally ranges from about 10 μm to about 50 μm. In one embodiment a conductive metal, preferably silver, filled epoxy termination is utilized as a termination.

The multilayer ceramic chip capacitor of the present invention generally is fabricated by forming a green chip by conventional printing and sheeting methods using pastes, firing the chip, and printing or transferring external electrodes thereto followed by baking.

Paste for forming the dielectric layers can be obtained by mixing a raw dielectric material with an organic vehicle. The raw dielectric material may be a mixture of oxides and composite oxides as previously mentioned. Also useful are various compounds which convert to such oxides and composite oxides upon firing. These include, for example, carbonates, oxalates, nitrates, hydroxides, and organometallic compounds. The dielectric material is obtained by selecting appropriate species from these oxides and compounds and mixing them. The proportion of such compounds in the raw dielectric material is determined such that after firing, the specific dielectric layer composition may be met. The raw dielectric material is generally used in powder form having a mean particle size of about 0.1 to about 3 μm, preferably about 1 μm.

The organic vehicle is a binder in an organic solvent. The binder used herein is not critical and may be suitably selected from conventional binders such as ethyl cellulose. Also the organic solvent used herein is not critical and may be suitably selected from conventional organic solvents such as terpineol, butylcarbinol, acetone, and toluene in accordance with a particular application method such as a printing or sheeting method.

Paste for forming internal electrode layers is obtained by mixing an electro-conductive material with an organic vehicle. The conductive material used herein includes conductors such as conductive metals and alloys as mentioned above and various compounds which convert into such conductors upon firing, for example, oxides, organometallic compounds and resinates. The organic vehicle is as mentioned above.

Paste for forming external electrodes is prepared by the same method as the internal electrodes layer-forming paste.

No particular limit is imposed on the organic vehicle content of the respective pastes mentioned above. Often the paste contains about 1 to 5 wt % of the binder and about 10 to 50 wt % of the organic solvent. If desired, the respective pastes may contain any other additives such as dispersants, plasticizers, dielectric compounds, and insulating compounds. The total content of these additives is preferably up to about 10 wt %.

A green chip then may be prepared from the dielectric layer-forming paste and the internal electrode layer-forming paste. In the case of printing method, a green chip is prepared by alternately printing the pastes onto a substrate of polyethylene terephthalate (PET), for example, in laminar form, cutting the laminar stack to a predetermined shape and separating it from the substrate.

Also useful is a sheeting method wherein a green chip is prepared by forming green sheets from the dielectric layer-forming paste, printing the internal electrode layer-forming paste on the respective green sheets, and stacking the printed green sheets. A capacitor with a large number of layers can be prepared in this manner as well known in the art. It is preferable to utilize additional layers which are narrower than standard capacitors. The combination of a higher number of narrower layers provides a finished capacitor with a width greater than the thickness. This facilitates packaging in such a way that the standard pick-and-place technology will easily orient the capacitors in the proper orientation.

The method of forming the capacitor is not particularly limiting herein.

The binder is then removed from the green chip and fired. Binder removal may be carried out under conventional conditions, preferably under the following conditions where the internal electrode layers are formed of a base metal conductor such as nickel and nickel alloys.

For binder removal the heating rate is preferably about 5 to 300° C./hour, more preferably 10 to 100° C./hour. The holding temperature is preferably about 200 to 400° C., more preferably 250 to 300° C. and the holding time is preferably about ½ to 24 hours, more preferably 5 to 20 hours in air. The green chip is fired in an atmosphere which may be determined in accordance with the type of conductor in the internal electrode layer-forming paste. Where the internal electrode layers are formed of a base metal conductor such as nickel and nickel alloys, the firing atmosphere may have an oxygen partial pressure of 10⁻⁸ to 10⁻¹² atm. Extremely low oxygen partial pressure should be avoided, since at such low pressures the conductor can be abnormally sintered and may become disconnected from the dielectric layers. At oxygen partial pressures above the range, the internal electrode layers are likely to be oxidized.

For firing, the chip preferably is held at a temperature of 1,100° C. to 1,400° C., more preferably 1,250 to 1,400° C. Lower holding temperatures below the range would provide insufficient densification whereas higher holding temperatures above the range can lead to poor DC bias performance. The heating rate is preferably 50 to 500° C./hour, more preferably 200 to 300° C./hour with a holding time of ½ to 8 hours, more preferably 1 to 3 hours. The cooling rate is preferably 50 to 500° C./hour, more preferably 200 to 300° C./hour. The firing atmosphere preferably is a reducing atmosphere. An exemplary atmospheric gas is a humidified mixture of N₂ and H₂ gases.

Firing of the capacitor chip in a reducing atmosphere preferably is followed by annealing. Annealing is effective for re-oxidizing the dielectric layers, thereby optimizing the resistance of the ceramic to dielectric breakdown. The annealing atmosphere may have an oxygen partial pressure of at least 10⁻⁶ atm., preferably 10⁻⁵ to 10⁻⁴ atm. The dielectric layers are not sufficiently re-oxidized at a low oxygen partial pressures below the range, whereas the internal electrode layers are likely to be oxidized at oxygen partial pressures above this range.

For annealing, the chip preferably is held at a temperature of lower than 1,100° C., more preferably 500° C. to 1,000° C. Lower holding temperatures below the range would oxidize the dielectric layers to a lesser extent, thereby leading to a shorter life. Higher holding temperatures above the range can cause the internal electrode layers to be oxidized (leading to a reduced capacitance) and to react with the dielectric material (leading to a shorter life). Annealing can be accomplished simply by heating and cooling. In this case, the holding temperature is equal to the highest temperature on heating and the holding time is zero. Remaining conditions for annealing preferably are as follows.

The binder removal, firing, and annealing may be carried out either continuously or separately. If done continuously, the process includes the steps of binder removal, changing only the atmosphere without cooling, raising the temperature to the firing temperature, holding the chip at that temperature for firing, lowering the temperature to the annealing temperature, changing the atmosphere at that temperature, and annealing.

If done separately, after binder removal and cooling down, the temperature of the chip is raised to the binder-removing temperature in dry or humid nitrogen gas. The atmosphere then is changed to a reducing one, and the temperature is further raised for firing. Thereafter, the temperature is lowered to the annealing temperature and the atmosphere is again changed to dry or humid nitrogen gas, and cooling is continued. Alternately, once cooled down, the temperature may be raised to the annealing temperature in a nitrogen gas atmosphere. The entire annealing step may be done in a humid nitrogen gas atmosphere.

The resulting chip may be polished at end faces by barrel tumbling and sand blasting, for example, before the external electrode-forming paste is printed or transferred and baked to form external electrodes. Firing of the external electrode-forming paste may be carried out in a humid mixture of nitrogen and hydrogen gases at about 600 to 800° C., and about 10 minutes to about 1 hour.

Pads are preferably formed on the external electrodes by plating or other methods known in the art.

The external terminations are preferably formed by dipping with other methods, such as ink-jet spraying being suitable. It is preferably that the external termination cover the end and a portion of the sides of the capacitor in a band which preferably extends to about ¼ but no more than ⅜^{th} the thickness of the capacitor.

The multilayer ceramic chip capacitors of the invention can be mounted on printed circuit boards, for example, by soldering.

The capacitors of the present invention are readily adaptable to tape and reel applications. The dimensions of the capacitor, as described herein, facilitates proper alignment in the cavity of the tape. Tape and reel applications and technology is well known in the art and further discussion is not necessary for an understanding of the instant invention.

### EXAMPLES

A series of conventional capacitors were mounted to a series of boards in a conventional manner with the plates parallel to the board. A second series of conventional capacitors were mounted to a series of boards in a conventional manner with the plates perpendicular to the board. A series of floating electrode capacitors were mounted to a series of boards in a conventional manner with the plates parallel to the board. As an inventive example a series of either floating electrode or open mode capacitors were mounted to a series of boards in a conventional manner with the plates perpendicular to the board. Each board was flexed to 10 mm and the percentage failure was determined. The capacitance was measured with a change of 0.2% being considered representative of a failure due to loss of capacitance. The results are provided in Table 1.

TABLE 1

| | Capacitor | Mounting | Failure |
|---|---|---|---|
| Comparative | Conventional | parallel | 90% |
| Comparative | Open Mode | parallel | 90% |
| Inventive | Open Mode | perpendicular | 0% |
| Comparative | Floating Electrode | parallel | >95% |
| Inventive | Floating Electrode | perpendicular | 0% |

As indicated in Table 1, the inventive examples with the capacitor plates perpendicular to the substrate illustrate a significant improvement with regards to the failure upon flexing. This improvement is unexpected.

The present invention has been described with particular reference to the preferred embodiments. It would be apparent from the description herein that other embodiments could be realized without departing from the scope of the invention which is set forth in the claims appended hereto.

1. An electrical component comprising:
a substrate comprising a planar surface;
a capacitor comprising:
a plurality of first plates and second plates wherein said first plates and second plates are non-contacting and in common planes;
a plurality of third plates parallel to said first plates and said second plates and interleaved between said planes;
a first external termination in electrical contact with said plurality of first plates;
a second external termination in electrical contact with said plurality of second plates;
wherein said capacitor is mounted on said substrate and said first plates, said second plates and said third plates are perpendicular to said planar surface;
wherein said first external termination covers an end and a portion of sides and extends at least ¼ but no more than ⅜^{th} the thickness of said capacitor along said sides of said capacitor.

2. The electrical component of claim 1 wherein said substrate comprises a circuit.

3. The electrical component of claim 1 wherein said capacitor is rectangular.

4. The electrical component of claim 1 wherein said capacitor has a width to thickness ratio of at least 1.1.

5. (canceled)

6. The electrical component of claim 1 with a first lead frame is attached to said first external termination and a second lead frame attached to said second external termination.

7. A printed circuit board comprising said electrical component of claim 1.

8. A printed circuit board comprising:
a substrate comprising a planar surface and circuit traces on said planar surface;
a capacitor in electrical contact with said circuit traces wherein said capacitor comprises:
a plurality of first plates and second plates wherein said first plates and second plates are non-contacting and in common planes;
a plurality of third plates parallel to said first plates and said second plates and interleaved between said planes;
a first external termination in electrical contact with said plurality of first plates;
a second external termination in electrical contact with said plurality of second plates;
wherein said capacitor is mounted on said substrate and said first plates, said second plates and said third plates are perpendicular to said planar surface; and
wherein said first external termination covers an end and a portion of sides and extends at least ¼ but no more than ⅜^{th} the thickness of said capacitor along said sides of said capacitor.

9. The printed circuit board of claim 8 wherein said capacitor is rectangular.

10. The printed circuit board of claim 8 wherein said capacitor has a width to thickness ratio of at least 1.1.

11. (canceled)

12. The printed circuit board of claim 8 with a first lead frame is attached to said first external termination and a second lead frame attached to said second external termination.

13. An electrical component comprising:
a substrate comprising a planar surface;
a capacitor with a first end, a second end opposite said first end and four sides perpendicular to said first end and said second end comprising:
a plurality of first plates and second plates wherein said first plates and second plates are parallel and alternating with dielectric there between;
a first external termination on said first end in electrical contact with said plurality of first plates;
a second external termination on said second end in electrical contact with said plurality of second plates;
wherein said first plates are separated a distance from the point at which said second external termination ends;
wherein said second plates are separated a distance from the point at which said second external termination ends;
wherein said capacitor is mounted on said substrate and said first plates and said second plates perpendicular to said planar surface.

14. The electrical component of claim 13 wherein said substrate comprises a circuit.

15. The electrical component of claim 13 wherein said capacitor is rectangular.

16. The electrical component of claim 13 wherein said capacitor has a width to thickness ratio of at least 1.1.

17. An electrical component comprising:
a substrate comprising a planar surface;
a capacitor with a first end, a second end opposite said first end and four sides perpendicular to said first end and said second end comprising:
a plurality of first plates and second plates wherein said first plates and second plates are parallel and alternating with dielectric there between;
a first external termination on said first end in electrical contact with said plurality of first plates;
a second external termination on said second end in electrical contact with said plurality of second plates;
wherein said first plates are separated a distance from the point at which said second external termination ends;
wherein said second plates are separated a distance from the point at which said second external termination ends;
wherein said capacitor is mounted on said substrate and said first plates and said second plates perpendicular to said planar surface wherein said first external termination covers an end and a portion of sides and extends at least ¼ but no more than ⅜^{th} a thickness of said capacitor along said sides of said capacitor.

18. An electrical component comprising:
a substrate comprising a planar surface;
a capacitor with a first end, a second end opposite said first end and four sides perpendicular to said first end and said second end comprising:
a plurality of first plates and second plates wherein said first plates and second plates are parallel and alternating with dielectric there between;
a first external termination on said first end in electrical contact with said plurality of first plates;
a second external termination on said second end in electrical contact with said plurality of second plates;
wherein said first plates are separated a distance from the point at which said second external termination ends;
wherein said second plates are separated a distance from the point at which said second external termination ends;
wherein said capacitor is mounted on said substrate and said first plates and said second plates perpendicular to said planar surface with a first lead frame attached to said first external termination and a second lead frame attached to said second external termination.

19. A printed circuit board comprising the electrical component of claim 13.

20. An electrical component comprising:
a substrate comprising a planar surface;
a capacitor comprising:
a plurality of first plates and second plates wherein said first plates and second plates are parallel and alternating;
a first external termination in electrical contact with said plurality of first plates;
a second external termination in electrical contact with said plurality of second plates;
a first lead frame attached to said first external termination and a second lead frame attached to said second external termination;
wherein said first lead frame and said second lead frame are mounted on said substrate with said first plates and said second plates perpendicular to said planar surface.

21. The electrical component of claim 20 wherein said substrate comprises a circuit.

22. The electrical component of claim 20 wherein said capacitor is rectangular.

23. The electrical component of claim 20 wherein said capacitor has a width to thickness ratio of at least 1.1.

24. A printed circuit board comprising the electrical component of claim 20.
